(19) United States
(12) Patent Application Publication
(10) Pub. No.: US 2009/0310511 A1
(43) Pub. Date: Dec. 17, 2009

(54) METHODS AND SYSTEMS FOR DYNAMICALLY CONFIGURING AND MANAGING COMMUNICATION NETWORK NODES AT THE MAC SUBLAYER

(75) Inventors: Raj Vaswani, Portola Valley, CA (US); Jana van Greunen, Redwood City, CA (US); William E. San Filippo, III, Los Altos Hills, CA (US); Sterling Hughes, San Mateo, CA (US)

Correspondence Address: BUCHANAN, INGERSOLL & ROONEY PC, POST OFFICE BOX 1404, ALEXANDRIA, VA, 22313-1404, US

(73) Assignee: Silver Spring Networks, Inc., Redwood City, CA (US)

(21) Appl. No.: 12/139,097

(22) Filed: Jun. 13, 2008

(51) Int. Cl. H04L 12/28

(52) U.S. Cl. 370/254

(57) ABSTRACT

Methods are disclosed for generating a data packet at a sending node of the network that conforms to a media access control (MAC) layer protocol for network communications. The data packet includes a MAC header and a data segment, wherein data in said data segment is encoded as a type-length-value element identifying a value for an operating parameter of the network. The data packet is transmitted from the sending node to a receiving node. At the receiving node, the data packet is processed at the MAC sublayer of network protocols to retrieve said element and determine the value for the operating parameter. Operating parameters within the receiving node are adjusted to conform to the determined value of the operating parameter.

### TECHNICAL FIELD

The present disclosure relates generally to the management and operation of devices connected by a computer network and, more particularly, to the dynamic configuration of such devices.

### BACKGROUND

Network devices employ protocol stacks that organize communication software in hierarchical layers. For instance, the Open System Interconnection (OSI) Model defines seven-layers, including four upper layers, which are directed to software applications, and three lower layers, which are directed to handling data packets. The upper layers include an application layer, a presentation layer, a session layer, and a transport layer. The three lower layers include a network layer, a data link layer and a physical layer. Network device management is typically implemented at the upper layers of the network and, to a limited extent, at the physical layer.

The data link layer (i.e., Layer 2), is responsible for ensuring node-to-node validity and integrity of transmissions. The data link layer (DLL) includes two sublayers: Logical Link Control (LLC) and Media Access Control (MAC). The MAC sublayer provides an interface between the LLC sublayer and the physical layer, and controls access to the physical transmission medium in a device. MAC sublayer functionality is typically built into a device's network interface card (NIC). Each NIC has a unique MAC identification number allowing delivery of data packets to a specific destination within a network.

Within some network communication protocols, a type-length-value (TLV) element may be encoded in a data packet to communicate optional information. The “type” indicates the kind of field that the “value” represents, the “length” indicates the size of the “value”, and “value” is a variable sized set of octets that contains the element's payload information. Header information is added at the beginning of a data packet in order to construct a packet ready for transmission over the network.

Communication protocols for the MAC sublayer have typically provided a fixed-frame format in which a predefined set of fields that occur in a predetermined order. To communicate, the devices in a network must adhere to the same, pre-specified MAC frame format. That is, a network node cannot send commands, settings or data unless such information transmissions comply with previously formatted fields of the MAC frame. However, because these MAC sublayer protocols require fixed frames, the protocols have limited the ways networks can be configured and operated. Further, such fixed-frame architectures are not readily extensible. Adding new MAC frame features requires significant changes to the implementation.

### SUMMARY OF THE INVENTION

Embodiments disclosed herein use the MAC sublayer to dynamically switch network modes, conditions and operations. The disclosed embodiments enable dynamic self-reconfiguration of network nodes, dynamic variation of security configuration, dynamic switching of radio interface operation, interoperability between nodes with different MAC-layer capabilities, other functionalities, and extensibility of the MAC sublayer protocol, without pre-configuring firmware or software in the network elements.

In some embodiments, a method for dynamically configuring a communication network at a MAC sublayer is provided. The method includes generating a data packet at a sending node of the network that conforms to a media access control (MAC) layer protocol for network communications. The data packet includes a MAC header and a data segment, wherein at least some of the data in said data segment is encoded as a type-length-value element, and the value contained in said element identifies a value for an operating parameter of the network. The data packet is transmitted from the sending node to a receiving node. At the receiving node, the data packet is processed at the MAC sublayer of network protocols to retrieve said element and determine the value for the operating parameter. Operating parameters within the receiving node are adjusted to conform to the determined value of the operating parameter.

It is to be understood that both the foregoing general description and the following detailed description are exemplary and explanatory only, and are not restrictive of the invention, as claimed.

### BRIEF DESCRIPTION OF THE DRAWINGS

FIG. 1 is a block diagram illustrating a network consistent with exemplary embodiments disclosed herein;

FIG. 2 is a block diagram illustrating an exemplary data packet consistent with exemplary embodiments disclosed herein; and

FIG. 3 is a flow chart illustrating a method of dynamically configuring a communications network node consistent with exemplary embodiments disclosed herein.

FIG. 4 is block diagram illustrating an exemplary embodiment disclosed herein.

### DETAILED DESCRIPTION

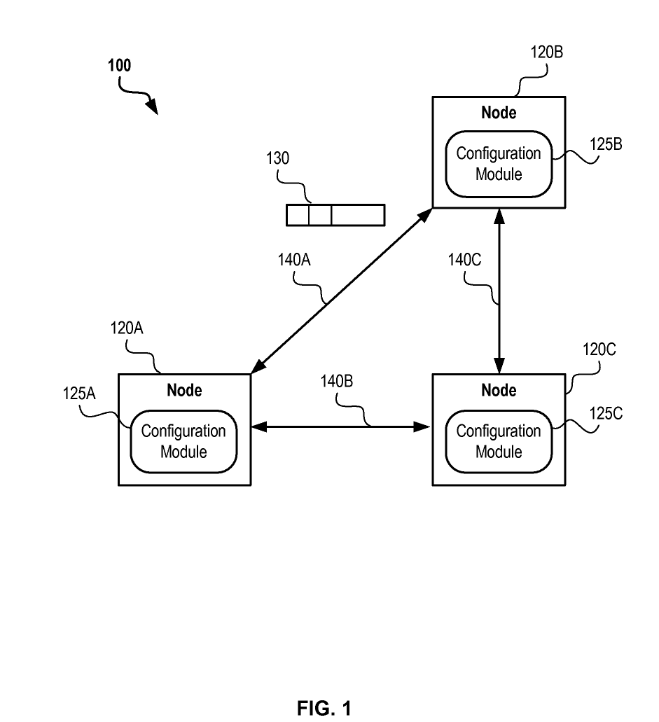

FIG. 1 is a block diagram illustrating an example of a network 100, which includes a plurality of nodes 120 connected by communications links 140, which may be wired, fixed wireless, or mobile wireless links. In network 100, messages can be divided and transmitted as data packets, such as data packet 130, according to packet-switching protocols, such as Transaction Control Protocol (TCP)/Internet Protocol (IP), X.25, and Frame Relay. Various embodiments of network 100 can be connected to another network, contain one or more other subnetworks, and/or be a subnetwork within another network. Several embodiments disclosed herein are applicable to wireless networks; for example, networks using 802.15 or 802.16 standards, and WCDMA/CDMA 2000 3G standard.

In some embodiments, network 100 is a wireless smart-grid network that monitors and controls a variety of nodes 120 that are devices for generating, distributing, monitoring and/or managing an electrical power service. These devices can connect customer meters and utility grid origination/ distribution points with a group of network management servers (e.g., control centers) via combination of wireless networks, Access Points (e.g., gateways) and/or wide area networks (WANs).

As illustrated in FIG. 1, node 120A can generate data packet 130 and transmit it to node 120B over communication channel 140A. Nodes 120 can be any intelligent device connected to a network 100 having hardware and software for transmitting and receiving data packets, and having a corresponding Media Access Control (MAC) identification number. For example, nodes 120 can be a general-purpose computer, server, a network device (e.g., gateway, switch, repeater, router), or application-specific device (e.g., residential power meter, remote sensor). Nodes 120 can further include an electronic data processing system or processor (not shown) executing computer instructions stored in a computer-readable storage device (e.g., random access memory, read-only memory, flash memory, magnetic memory or optical memory) for various software modules related to controlling nodes 120 and transmitting data packets between them.

Nodes 120, as shown in FIG. 1, also can include respective configuration modules 125 (a.k.a. “control modules”) that manage the nodes' communications in network 100. For instance, configuration module 125A can process, store and retrieve parameters for controlling and configuring the communication, functionality and capabilities of node 120A. In addition, configuration module 125A can store and receive information about other nodes in network 100. Based on the communication parameters, configuration module 125A may determine whether a node 120 should request information from other nodes, or update its configuration. Via configuration module 125A, node 120A can also trigger other nodes 120B and 120C to perform some action, such as updating their respective software and/or firmware.

Although configuration module 125 is described as a single software module, configuration module 125 may be implemented as a hardware device, a combination of hardware and software, or as a plurality of software modules to provide the above-described functionality of configuration module 125. Moreover, as described in greater detail below, such configuration-related information can be exchanged between nodes using type-length-value (TLV) elements at the MAC sublayer.

Employing variable-length TLV packets in the MAC sublayer provides several benefits. First, variable-length TLV packets allow flexibility for dynamically and selectively adding new features to the protocol to implement new or modified network functionalities (e.g., protocol extensibility). Additional command types or features that may not be initially included in a protocol can be added at any time in a backwards-compatible way. For example, a network node that knows about the latest TLV type definition included in the data packet will process the TLV's respective payload. Other nodes that do not recognize the designated type still can decode the length field and skip over the unrecognized TLV, and process the other TLVs in the packet. TLVs with recognized types are processed, and the unrecognized types are skipped.

Also, variable-length TLV packets allow for old commands that are no longer used, to be deprecated (i.e., obsolesced and/or removed) from nodes 120. With a fixed frame format in standard MAC protocol implementations, if a feature is no longer used, it is not possible to simply remove the bits or message fields that are used to specify the feature information. This is because all nodes are configured to properly construct frames for transmission and decode frames upon reception, utilizing a pre-established frame format. If a node changes the frame structure upon transmission, the target node will not be able to decode the frame until it is reconfigured to be compatible with the new frame structure. As such, in standard MAC sublayer protocol implementations, nodes cannot interoperate with a changed frame format. However, in the MAC sublayer protocol disclosed herein, a deprecated TLV definition can be easily removed and/or updated. A deprecated TLV may be replaced with a new TLV with the same or different functional characteristics.

Moreover, a variable-length TLV packet provides a way to exchange configuration information between nodes 120. For example, node 120A can send TLVs in data packet 130 that signals node 120B to perform a firmware and/or software upgrade. The TLVs can also be used as a mechanism to distribute the description of the upgrade in network 100 at the MAC sublayer. For example, by altering a set of MAC TLVs, nodes 120 in network 100 can be changed from a pseudo-802.16 frame format to a 802.15.4 frame format, and achieve the desired network environment and functionality.

Although network 100 is illustrated in FIG. 1 as a simplified example, and is sometimes discussed in terms of a utility network, any network having intelligent nodes may benefit from embodiments disclosed herein. For instance, network 100 may be a cable television network, satellite communications network, sensor network, and an ad-hoc wireless networks.

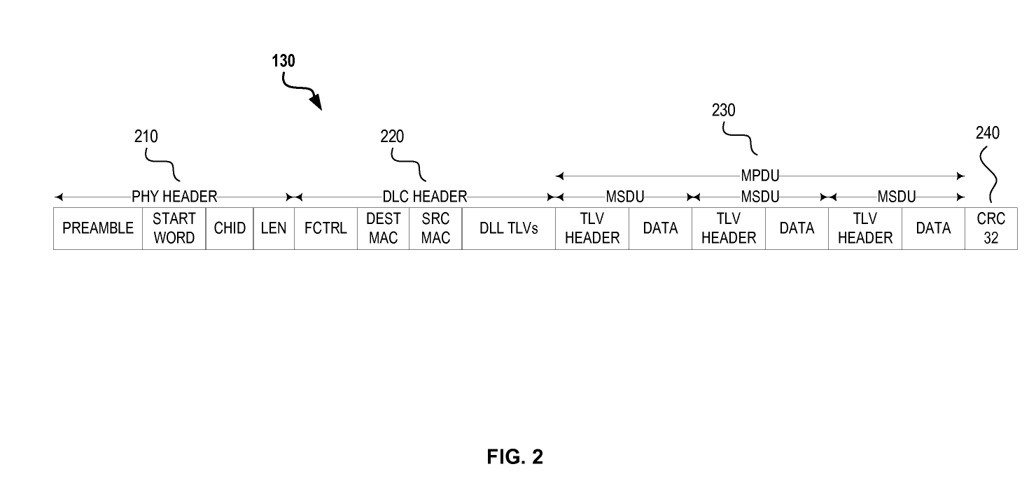

FIG. 2 illustrates a diagram of an exemplary data packet 130 consistent with embodiments disclosed herein. Packet 130 is comprised of several portions including a physical (PHY) layer header 210, data link control (DLC) header 220, and MAC Protocol Data Unit (MPDU) 230. The DLC header and the MPDU together constitute a MAC-sublayer data packet. This packet is wrapped into a PHY layer packet by adding the PHY header 210 at the beginning. A frame check sequence 240, e.g., a 32-bit cyclic redundancy check, is appended to the end of the packet.

In PHY header 210, the preamble comprises a binary sequence of bits that enables a receiving node, such as node 120B, to detect a signal and achieve frequency and timing synchronization with the remainder of a packet, such as data packet 130, received from a source node, such as node 120A. This synchronization field is followed by a start word, which is comprised of a known binary sequence of bits that, when successfully decoded, trigger node 120B to decode data packet 130 that follows. Among other features, the start word provides symbol-level synchronization, and optimizes autocorrelation properties in conjunction with the preamble sequence of alternating bits that preceded it. Where network 100 is a network that employs frequency hopping, a Channel ID (CHID) indicates the particular channel, (i.e., frequency band) on which packet 130 is being transmitted. A length field (LEN) indicates the length of the remaining portion of packet 130 the follows the field.

DLC header 220 is the header of the MAC data packet and includes a Frame Control Field (FCTRL). As shown in FIG. 2, DLC header 220 can include a Destination MAC Address (DEST MAC), a Source MAC Address (SRC MAC), and DLL TLVs. Destination MAC Address (DEST MAC) is the unique MAC address of the ultimate target node for the packet, such as node 120B. Source MAC Address (SRC MAC) is the unique MAC address of a sending node, such as node 120A.

DLL TLVs are used to convey information within a communications link, and are processed by the DLL during the communication link. A communication link between any two nodes 120A and 120B can consist of, for example, the exchange of four data packets. Node 120A can first poll node 120B to inform it that node 120A has data to send, and determine whether node 120B is available to receive the data. If node 120B is available, it returns an acknowledgement packet to node 120A. In a network that employs frequency hopping, the acknowledgment also causes node 120B to remain on the current frequency channel to receive the data, rather than hopping to the next channel in its sequence at the allotted time. Upon receiving the acknowledgment, node 120A sends a data packet with the data intended for node 120B. If node 120B is able to successfully receive and decode the packet, it returns an acknowledgement to node 120A.

Data packet 130 can have a variety of DLL TLVs, for example a protocol may define a communication link information (CLI) TLV, a Sequence Control TLV, and a Data Link Layer (DLL) Cyclic Redundancy Check (CRC) TLV. For instance, one or more CLI TLVs may be used to convey channel control parameters. One example may involve channel parameters of a frequency hopping spread spectrum (FHSS) network, including such items as timing and synchronization. The DLL CLI TLV can be by used by node 120A to convey timing synchronization information to neighboring nodes 120B & 120C.

The DLL CLI TLV may also be used to convey timing and priority information inside the communications link. For example, the CLI DLL TLV can communicate ‘tx priority’ and ‘tx time’ fields that are the priority and transmit time of the next packet to be transmitted in a communications link. ‘Rx priority’ and ‘Rx time’ fields that are used to define the allowed priority and length of the response to the packet that contains this TLV. The presence of this TLV also means that a response to the packet that contains this TLV is expected inside the communications link. If no DLL CLI TLV is present in a packet sent within a communications link, it is implied that both the transmit time and receive time are zero and that one end of the communications link wishes to terminate the communications link.

The DLL CRC TLV may be used to ensure that no corrupt packets are handed to the MAC. The cyclic redundancy check is calculated over the entire MAC/DLL portion of the packet and can be the same CRC-32 algorithm used by the MFE. Thus, when the DLL CRC is added to a packet, the resultant PHY CRC-32 should equal zero. This minimizes receive processing time at the DLL because the DLL does not have to calculate the received CRC; it simply checks that the PHY CRC-32 is equal to zero.

In addition, the DLL TLV may be used to configure sequence control parameters. One example may be DLL Sequence Control TLV that is designed for DLL fragmentation and duplicate detection purposes. MAC packets handed to the DLL may be fragmented by the DLL in order to increase the likelihood of reception.

Also, the DLC End TLV can be used to denote the end of DLL TLVs in a packet. This TLV is added if the packet data is a fragment of a MAC packet since the DLL needs to see a MAC TLV to stop processing DLL TLVs in a received packet.

There are several applications above the MAC sublayer that hand down packets for it to transmit. Example applications include: network layer or IPv6, MLME, IMU (for example gas or water meter devices in utility networks), rf ping protocol, and others. These applications do not interact and they send their packets to the MAC asynchronously. The MAC sublayer protocol described herein can combine the packets from these applications into a single packet on the transmit side, and then de-multiplex it again on the receive side. By combining these smaller packets into one PHY layer data frame, the overhead of targeting the node for each packet (poll-ack message), as well as the additional octets added by the MAC and data-link layer TLV'S, is avoided.

There are two mechanisms that help achieve packet combination. The first is the use of TLV's to encode the start and end of each payload. This allows the MAC sublayer to demultiplex the payload at the receive side. In the case where a larger packet is fragmented, a particular application's payload can be handed up as soon as it is received in its entirety, even if the rest of the packet has not yet been received. The second mechanism is that when the MAC does the security (authentication), the required security information is inserted into the packet as a TLV. The security at the MAC typically relies on computing a cryptographic function over the node's certificate and the packet's contents. If the MAC is handed more payload for a packet, it can simply append this payload to the end, remove the existing security TLV, and then compute the new security TLV. Therefore there is no additional authentication overhead to combining multiple payloads from the different applications.

There are two mechanisms that help achieve packet combination. The first is the use of TLV's to encode the start and end of each payload. This allows the MAC sublayer to demultiplex the payload at the receive side. In the case where a larger packet is fragmented, a particular application's payload can be handed up as soon as it is received in its entirety, even if the rest of the packet has not yet been received. The second mechanism is that when the MAC does the security (authentication), the required security information is inserted into the packet as a TLV. The security at the MAC typically relies on computing a cryptographic function over the node's certificate and the packet's contents. If the MAC is handed more payload for a packet, it can simply append this payload to the end, remove the existing security TLV, and then compute the new security TLV. Therefore there is no additional authentication overhead to combining multiple payloads from the different applications.

Another aspect of the MAC TLVs is that they can be used to configure nodes for a particular type of operation. Network parameters can be dynamically adjusted via TLVs in the MAC packet sent from a source node requesting the change to a target node that will process the TLVs to implement the requested or suggested change.

In one example, the TLVs can be used to request a change in modulation. The modulation parameter may be identified as TYPE 17, for instance. Known modulation techniques can be encoded as follows: 1 FSK—with number symbols to designate individual implementations of frequency and shift frequency, such as BPSK, QPSK, 8PSK, 16PSK, etc.; 2 ASK; 3 OFDM; and 4 QAM. In this instance, the TLV to change to QPSK would be: Type=17, Length=2, Value=1, 4. In another example, the TLV to change to OFDM would be: Type=17, Length=1, Value=3.

In another example the TLVs can be used to request a change in the FHSS Hopping Sequence. The FHSS Hopping Sequence parameter may be identified as 18, for example, the value indicates the new seed, number of channels and slot time, each encoded as octets. To change to a new configuration with new seed=45, number of channels=213, and the slot time=10 ms, the example TLV for the hopping sequence change request would be: Type=18, Length=3, Value 45, 213,10. Similar examples can be constructed to implement changes in other types of parameters (for example: timing and synchronization parameters of an FHSS network; sequence control; last gasp packet thresholds in a utility network; power management parameters; routing algorithm modification). In response to receiving a MAC sublayer packet containing these types of TLVs, nodes 120 can change operating parameters designated by the TLVs according to the value contained therein, and operate with the new configuration. The change could be instantaneous, or another TLV in the packet could be used to specify a particular time at which the change in configuration is to take place so that all nodes 120 are reconfigured in synchronism.

In yet another example, the MAC TLVs can be used to auto-discover neighboring nodes' capabilities and/or updated MAC format. As such, variable-length TLV's disclosed herein may enable nodes 120 to adapt at the MAC sublayer to the capabilities of their neighbors. For example, node 120A can send a MAC message to a neighbor node 120B with a TLV called “TLV Info Req”, with the purpose of eliciting a response including information on the functional capabilities of the node 120B and the TLVs that node 120B is able to process. Upon receipt of this message by the node 120B, the node responds by transmitting a MAC message to node 120A with a TLV called “TLV Info Rsp” with information on all the TLVs that node 120B currently is able to process. Thus, neighbor nodes 120A and 120B can dynamically exchange information on each other's capabilities and/or discover common functionality. This enables a “configuration dialogue” between nodes, in which nodes request and assist in reconfiguration of other nodes in the network to achieve additional processing and functional capabilities, compatibility, optimization, and other features. Such capability allows nodes 120 in network 100 to dynamically adapt their MAC-layer packets to be compatible and optimal to their current situation. Some examples of dynamic reconfiguration of the nodes may be: (a) reconfiguration of security parameters to overcome or protect against any threats or violations; (b) quick modification of RF channel parameters in response to a network interference environment; (c) modification of present routing algorithm or implementation of new routing algorithm; and (d) requests from the back office server to reconfigure and report on certain types of monitoring or network information. Similarly, the TLVs can be used as a mechanism to signal (to neighbor network nodes) regarding firmware/software upgrades and also as a mechanism to distribute the description of the upgrade at the MAC sublayer.

In still another example, a set of one or more TLVs in the MAC packet of nodes 120 in network 100 can be used to signal to nodes 120 that they need to upgrade part of the MAC frame to obtain the latest code. Some examples of the “latest code” may be: new security policy, new channel optimization scheme, power adjustments, routing algorithm, localized data processing software, and others. System software/firmware upgrades are routine in communications networks and are currently implemented via lengthy and resource-consuming processes.

As noted above, a configurable “policy engine,” such as configuration module 125, may be included in each node 120. Configuration module 125 may indicate a threshold at which a node must determine where and how to obtain new or unknown TLV definitions. For instance, based on information received from neighboring nodes, such as nodes 120B and 120C, node 120A can determine whether a predetermined threshold has been exceeded. The threshold can be, for instance, a combination of the percentage of neighbors that use the TLV and/or the number of times the node has received the new TLV. Once a node has determined to obtain information about an unknown TLV, there are two places from which the node can fetch the information. First, the node may obtain such information from a general server at the application layer (Layer-7). Second, at the MAC sublayer (Layer-2), the node can request the definition from a neighboring node using the “TLV info req” TLV. This TLV causes neighboring nodes to respond with all TLVs it knows about or has available, but when received with a numerical argument, e.g. ID 18, it sends an XML-like description of the data contained in TLV ID-18 back in the “TLV info rsp” TLV.

The capability is not limited to obtaining information of TLV definitions. It can also be applied to any other program instructions that are processed by nodes 120 at the MAC sublayer. When a command is received to execute certain code, a node, such as node 120A determines whether it possesses the designated code. If not, node 120A can obtain the necessary code in one of several ways. First, node 120A can explicitly request the code from an external resource, such as a neighboring node (e.g., 120C). Second, node 120A may construct the code by applying specific values supplied with the command, for example, in the form of a TLV, to a generic code template, and compiling the result. Third, node 120A can dynamically generate the code based upon functional specifications provided with the command.

Configuration module 125 may be further constructed to set up a network-wide policy as to which nodes 120, when and how each of nodes 120 may receive information on TLVs, new TLVs themselves, and achieve new configuration environment. Further, this policy may be implemented on a network-wide basis, where nodes 120 are reconfigured with a new functional capability or network mode.

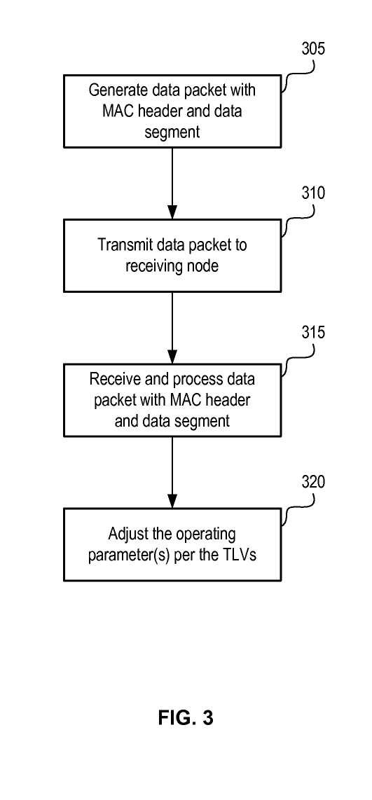

FIG. 3 is a flow chart illustrating an exemplary method of dynamically configuring a communications network. At a sending node of the network, such as node 120A, a data packet 130 is generated that conforms to a media access control (MAC) layer protocol for network communications, including a MAC header and a data segment. (Step 305.) At least some of the data in the data segment is encoded as a TLV element. In addition, the value contained in the element identifies a value for an operating parameter of the network. The data packet from the sending node 120A is transmitted to a receiving node, such as node 120B. (Step 310.) At the receiving node, the data packet is processed at the MAC sublayer of network protocols to retrieve the element and determine the value for the operating parameter. (Step 315.) Using information received in the data packet, the operating parameter within the receiving node 120B is adjusted to conform to the determined value. (Step 320.) Based on the operating parameters, configuration module 125B in node 120B may update one or more of node 120B's network operating parameters.

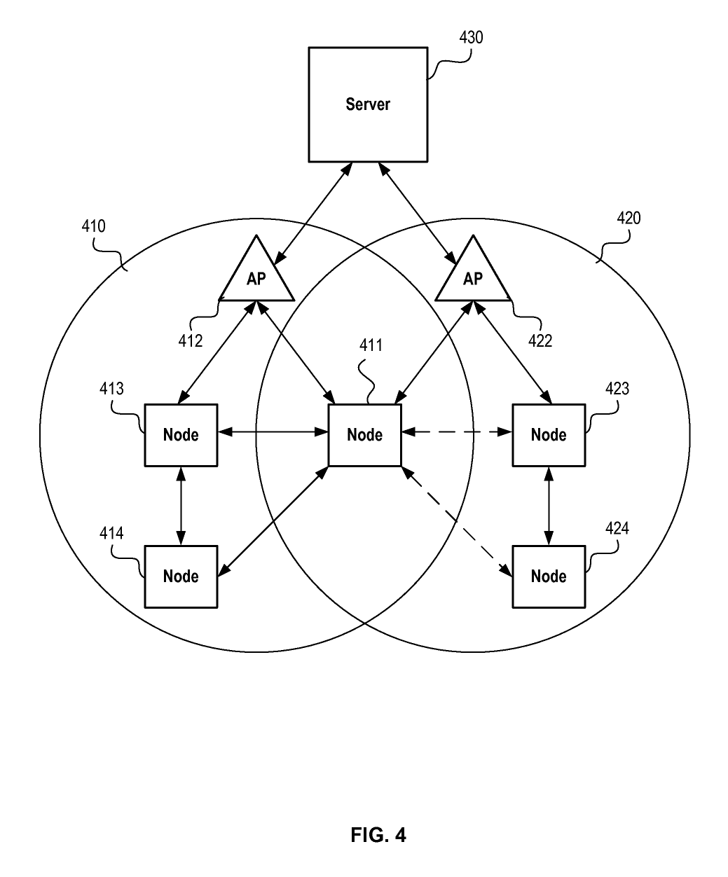

One exemplary embodiment is illustrated in FIG. 4, which includes two overlapping networks, 410 and 420. Both networks 410 and 420 employ a TLV-based MAC frame format consistent with this disclosure, but each network operates at different frequencies and utilizes different network parameters. Exemplary node 411 has hybrid RF capabilities, and as such, can transmit/receive at the frequencies utilized by networks 410 and 420. For the purposes of this example, assume node 411 is a member of network 410 and is configured to interoperate with its neighbors 413 & 414, and with a server 430 using a gateway 412 as its egress point.

As shown in FIG. 4, network 420 also includes a gateway 422. If gateway 422 has complete hybrid capability, nodes in both network 410 and network 420 can interoperate with gateway 422, including, for example, registering, obtaining IP prefix, and regressing their respective networks to central server 430.

At some time, an event may cause node 411 to join network 420. For instance, node 411 may periodically check for new networks, node 411 may look for new network after failing to communicate with network 410 for a predetermined period, and/or gateway 412 or server 430 may instruct node 411 to join another network under special circumstances (e.g., failures, security compromises, changes in node assignments, etc.). Because node 411 and gateway 422 have hybrid capabilities, they can communicate, as indicated by the solid line between them. However, according to this example, node 411 is not initially configured to interoperate in network 420 and, as such, it cannot yet interoperate with nodes 423 and 424 in network 420, as indicated by the dashed lines.

To join network 420, node 411 sends an “Info Request” TLV to gateway 422, requesting network 420 operating parameters. In response from gateway 422, node 411 receives a “Info Response” message from 422 with the needed TLVs. Node 411 processes the information received from gateway 422 using, for instance, configuration module 125 to implement the changes to, for instance, nodes 41 1's network operating parameters and TLV definitions. Once the implementation is complete, node 411 conducts discovery, registration, next (uplink) neighbor identification for routing, and other operations. From this point on, node 411 becomes a fully operational node in network 420.

With the TLV based MAC implementation described herein, configuration requests which are not supported by the particular node are automatically ignored, and thus do not impact the operation of the node within the network; it continues to operate within its capabilities. Resultant lack of response to a configuration request which is not understood can be an implicit signal to the requester that the node capabilities will not support the request. No specific protocols are needed in this case to handle legacy nodes. In this manner, TLV based MAC implementation allows for coexistence and interoperability of legacy nodes and newer nodes introduced (installed) into the network without specific coordination.

While illustrative embodiments of the invention have been described herein, the scope of the invention includes any and all embodiments having equivalent elements, modifications, omissions, combinations (e.g., of aspects across various embodiments), adaptations and/or alterations as would be appreciated by those in the art based on the present disclosure. The limitations in the claims are to be interpreted broadly based on the language employed in the claims and not limited to examples described in the present specification or during the prosecution of the application, which examples are to be construed as nonexclusive.

While certain features and embodiments of the invention have been described, other embodiments of the invention will be apparent to those skilled in the art from consideration of the specification and practice of the embodiments of the invention disclosed herein. Although exemplary embodiments have been described with regard to certain networks, the present invention may be equally applicable to other network environments having configurable, intelligent nodes. It is therefore intended that the specification and examples be considered as exemplary only, with a true scope and spirit of the invention being indicated by the following claims.

What is claimed is:

1. A method for dynamically configuring a communications network, comprising:
at a sending node of the network, generating a data packet that conforms to a Media Access Control (MAC) sublayer protocol for network communications, including a MAC header and a data segment, wherein at least some of the data in said data segment is encoded as a type-length-value (TLV) element, and the value contained in the type-length-value element is an operating parameter for the network;
transmitting said data packet from the sending node to a receiving node;
at the receiving node, processing said data packet using the MAC sublayer protocol to retrieve said TLV element and determine the parameter; and
adjusting said operating parameter within said receiving node to conform to the determined value.

2. The method of claim 1, wherein adjusting operating parameters includes requesting configuration information from another node.

3. The method of claim 2, including:
generating new software or firmware at the receiving node utilizing the configuration information from the other node.

4. The method of claim 2, wherein the configuration information is a functional capability that is new to the receiving node.

5. The method of claim 2, wherein requesting configuration from another node includes:
searching the network for a TLV definition corresponding to the adjusted operating parameter in the receiving node.

6. The method of claim 1, wherein:
the retrieved TLV element includes a TLV type that is deprecated; and
adjusting the operating parameter includes removing the definition of the deprecated TLV type from the MAC sublayer protocol at the receiving node.

7. The method of claim 1, wherein processing the data packet includes:
skipping any segments of the TLV element that do not comply with the MAC sublayer protocol at the receiving node.

8. The method of claim 1, wherein the operating parameters define timing and priority information for a communication link between the sending node and receiving node.

9. The method of claim 1, wherein the operating parameters define a modulation frequency for the network.

10. The method of claim 1, wherein the operating parameters define timing and synchronization for the sending node.

11. The method of claim 1, wherein the operating parameters define a Frequency-Hopping Spread-Spectrum hopping sequence parameter.

12. A method for dynamically configuring a node in a communications network, comprising:
receiving a data packet transmitted from another node over the network, the data packet including information encoded as a type-length-value (TLV) element, and
determining whether element includes a header corresponding to a Medium Access Control (MAC) protocol;
extracting the information from the packet based on the MAC protocol; and
adjusting a configuration of the node based on the extracted information.

13. The method of claim 12, wherein:
the information extracted from the TLV element includes a type value that is undefined at the node, and
adjusting the configuration of the node includes:
receiving a definition for the TLV type from another node in the network; and
adding the received definition for the TLV type to the MAC protocol at the node.

14. The method of claim 12, wherein adjusting the configuration of the node includes:
requesting configuration information from another node in the network; and
generating new software or firmware at the node utilizing the configuration information received from the other node.

15. The method of claim 14, wherein adjusting the configuration of the node includes:
searching the network for a TLV definition corresponding to the adjusted configuration of the node.

16. The method of claim 14, wherein the configuration information is a functional capability that is new to the node.

17. The method of claim 12, wherein:
the information extracted from the TLV element includes a TLV type that is deprecated; and
adjusting the configuration of the node includes removing the definition of the TLV type from the MAC protocol at the node.

18. The method of claim 12, wherein extracting information from the packet includes:
skipping any segments of the TLV message that do not comply with the MAC protocol at the node.

19. The method of claim 12, wherein the information extracted from the TLV element includes a TLV value indicating timing and priority information for a communication link.

20. The method of claim 12, wherein the information extracted from the TLV element includes a TLV value indicating a cyclic redundancy check value.

21. The method of claim 12, wherein the information extracted from the TLV element includes a TLV value indicating a modulation frequency for the network.

22. The method of claim 12, wherein the information extracted from the TLV element includes a TLV value indicating an epoch tick parameter.

23. The method of claim 12, wherein the information extracted from the TLV element includes a TLV value indicating a frequency-hopping spread-spectrum hopping sequence parameter.

24. A method for communicating in a network having a plurality of nodes, said network having a plurality of communication layers including a media access control (MAC) layer that interfaces with a physical layer and one or more other layers, said method comprising:
receiving a TLV message at a node in the network, the TLV message being received at the MAC layer; and
parsing the TLV message into a plurality of segments, wherein the parsed segments comply with a predetermined message format policy at the node.

25. The method of claim 24, wherein parsing includes skipping any segments of the TLV message that do not comply with the message format policy.

26. The method of claim 24, wherein the plurality of nodes include a TLV processing engine at the MAC layer.

27. The method of claim 24, wherein different ones of the plurality of nodes have different message format policies.

28. A method for communicating in a network including a plurality of nodes, said network having a plurality of communication layers including a media access control (MAC) layer that interfaces with a physical layer and one or more other layers, said method comprising:
transmitting a first TLV message at the MAC layer;
receiving, in response to the first TLV message, a second TLV message at the MAC layer, said second TLV message including configuration information of a node in the network; and
changing the configuration of a second node based on the configuration information.
